(19) United States
(12) Patent Application Publication
(10) Pub. No.: US 2004/0166864 A1
(43) Pub. Date: Aug. 26, 2004

(54) Minimising signal interference within a wireless network

(76) Inventors: Stephen Hill, Western Australia (AU); Dickson Poon, Western Australia (AU); David Parsons, Western Australia (AU)

Correspondence Address: Michael D Bednarek, Shaw Pittman, 1650 Tyson Boulevard, McLean, VA, 22102, US

(21) Appl. No.: 10/473,065

(22) PCT Filed: Mar. 28, 2002
(86) PCT No.: PCT/AU02/00394

(30) Foreign Application Priority Data
Mar. 28, 2001 (AU) PR 4053
Mar. 28, 2001 (AU) PR 4054

(51) Int. Cl. H04Q 7/20

(52) U.S. Cl. 455/450

(57) ABSTRACT

A wireless telecommunications network (100) comprises a multiplicity of Bluetooth™ units, some of which are fixed and act as base units (BS1; BS2; BS3; BS4) and some mobile (MS1; MS2; MS3; MS4). The fixed units are connected to a Local Area Network (LAN) along with a telephony gateway (4) and a PABX (5) and PSTN (6). Methods for minimising signal interference as mobile units roam within the network are discussed.

### FIELD OF THE INVENTION

The present invention relates to a method for minimising signal interference in a wireless network particularly, although not exclusively, between wireless Bluetooth™ devices, in a Pico-cellular network, such as a Personal Area Network.

### BACKGROUND ART

Personal productivity devices such as mobile phones, laptop computers, personal digital assistants (PDAS) and headsets have traditionally been connected together by cables. The major shortcomings of this approach include the number of cables to be carried around and the difficulties of getting compatible connections between devices from different vendors.

New wireless technologies have emerged recently that allow these devices to interwork without cables. These technologies are specifically designed to provide a very cost effective, standardised solution for an individuals devices to interwork within their “personal space”. They are short range, they carry multimedia information content, they are standardised and they deliver a “Personal Area Network” (PAN).

The PAN provides a useful solution for an individual and his personal devices. A logical extension to this model is for one member of the PAN to be a laptop or PC that is connected to a corporate Local Area Network (LAN). Extending this concept to an office environment leads to the conclusion that there will be many PANs in an office; in the extreme each office worker will have an individual PAN with a LAN connection.

Such a managed group of PANs is described as a “meta-PAN”. A meta-PAN allows the individual personal productivity devices to be integrated into the enterprise information systems. This integration is achieved by applying policies to manage, for example, radio interference between PANs, security and access control of devices, coverage, capacity and connectivity to central services.

One such wireless standard that has been developed is the Bluetooth™ standard developed by a consortium of parties and intended to achieve interoperability between different wireless devices—even if produced by different manufacturers. Bluetooth is known to persons skilled in the art and therefore need not be described in full detail herein. For further details, the addressee is directed to the Bluetooth Specifications provided by the Bluetooth Special Interest Group.

Summarised below are the main aspects relating to Bluetooth.

Bluetooth devices are radio-based devices, and are designed to operate within PANs of, typically, cell radii ranging from less than 10 m to more than 100 m in ideal conditions. The majority of battery-powered devices, are likely to operate with a 10-20 m cell radius.

Bluetooth devices operate in a frequency band of between 2.4 and 2.5 GHz with a transmitting power of between 1 and 100 mW. The maximum bit rate at which data is transferred is 1 Mbit's although this is effectively lower, but has been estimated as being up to 721 kbits/s.

In Bluetooth there are a number of defined profiles and usage models. A usage model describes a number of user scenarios—such as file transfer, dial-up networking, LAN access, synchronisation, telephone to service provider connection, and the use of a wireless headset acting as a remote audio input/output device. A profile defines options in each protocol that are mandatory for that profile, as well as parameter ranges for each protocol.

There are a number of Bluetooth profiles, and these are set out in the Bluetooth Specification as laid down by the Bluetooth Special Interest Group. These profiles include Generic Access Profile, (GAP), service Discovery Application Profile, (SDAP), Serial Port Profile and Generic Object Exchange Profile (GOEP).

There are a number of core Bluetooth protocols:

Baseband—which enables the physical Radio-frequency (RF) link between bluetooth devices, and controls the Bluetooth devices' synchronisation and frequency hopping sequence (discussed below). There are two different links—Synchronous Connection Oriented (SCO)—mainly for audio, and Asynchronous Connectionless (ACL)—mainly for data. The two links can be multiplexed to use the same RF link.

Host Controller Interface (HCI)—provides an interface for accessing hardware capabilities, a command interface to the Baseband Controller and Link Manager, and contains control and event registers.

Link Manager Protocol (LMP)—which is responsible for the link set-up between bluetooth devices, power management, and authentication and encryption.

Logical Link Control and Adaptation Protocol (L2CAP)—provides connection-oriented and connectionless data services, such as multiplexing, segmentation and reassembly of data packets, as well as “quality of service” information between bluetooth devices.

Service Discovery protocol (SDP)—allows for discovery of new services available.

RFCOMM—is a serial port emulation protocol.

Telephony Control (TCS)—defines control signalling for the establishment of speech and data calls between Bluetooth devices.

There are also a number of adopted protocols, including PPP, TCP/UDP/IP, Obex, and WAP.

These adopted protocols are well known to persons skilled in the art, and need not be described in any further detail herein.

A Bluetooth piconet can include up to eight separate bluetooth devices. When Bluetooth devices are communicating, one is defined as the “Master” and the rest are defined as “Slaves”. The master unit has a system clock and identity that are central to the operation of the frequency hopping. This Is well known to persons skilled in the art, and need not be described in any further details herein.

Bluetooth uses a frequency hopping technique to avoid interference between RF transmissions. In this technique, the frequency band is divided into a number of hop channels; with a different hop channel being used every 625 μs time slot i.e. at a rate of 1600 hops per second. Every hop channel is a fraction of the total frequency band. The hop from one channel to another is affected in a pseudo-random order.

Gaussian shaped binary Frequency Shift Key modulation is used, and full duplex transmission is achieved using time division multiplexing wherein subsequent slots are used for transmission and reception. The baseband protocol is a combination of circuit and packet switching. Data is sent in packets—each packet being sent within one time slot. Each packet includes a 72-bit access code, then a 54-bit header code, and followed by the data file/payload of anything from zero to 2745 bits i.e. up to 340 bytes. The access code is based on the identity of the master, and it's system clock

Any two Bluetooth devices can set up an ad-hoc connection, which is called a Piconet. As mentioned above, a piconet can include up to eight bluetooth devices, of which one is the master, and the other are slaves. There is no difference between bluetooth units in terms of the hardware and software that determines their roles, and, therefore, any Bluetooth device can be a master, and any can be a slave. The device that establishes the piconet is the master, and roles within a piconet can be changed, so that a slave can become a master and vice versa. The master unit controls all traffic in the piconet, and allocates capacity for SCO and polling for ACL links. Every slave unit is addressed in a specific order and polling scheme. Slave units can only transmit in response to an address from the master in the preceding time slot. If no information is sent to the master in response to being addressed, then a packet including only the access code and header is sent.

Before joining a piconet, a bluetooth device is in standby, in which the unit periodically “listens” for paging messages—every 1.28 seconds. These paging messages are transmitted on hop carriers known as “wake-up” carriers. The wake-up sequence is transmitted by the master on the wake-up carriers. The slave listens for 18 slots on the wake-up carrier and compares the incoming signal with the access code derived from its own identity, and, if there is a match, the slave invokes a set-up procedure and enters a Connected Mode. The correct access code and wake-up sequence are calculated using the specific slave's identity and system clock. To keep track of the slaves' system clocks, a paging procedure is defined for the master.

If multiple piconets cover the same area, a unit can participate in two or more overlaying piconets by applying time multiplexing. To participate on the proper channel, it should use the associated master device address and proper clock offset to obtain the correct phase. A Bluetooth unit can act as a slave in several piconets, but only as a master in a single piconet: since two piconets with the same master are synchronized and use the same hopping sequence, they are one and the same piconet. A group of piconets in which connections exist between different piconets is called a scatternet.

It is common for some Bluetooth devices to be mobile units, or Mobile Stations (MS), which will move about the network. For example, an individual may take his mobile phone and or PDA with him when he walks down the corridor to attend a meeting in another office. Once in the other office, he may wish to retrieve his emails, which will require that his mobile phone or PDA be able to communicate with a local base unit—commonly referred to as a Base Station (BS). This is called roaming, and the idea of roaming is well known in the field of cellular radio telecommunications.

If a significant number of Mobile Stations congregate within a limited space, then we would expect some signal degradation to occur when two or more base station transmissions collide at the Mobile Station's location. This is due to each Base Station performing a high number of transmissions per unit time at varying channel frequencies, chosen over a relatively small number of possible channels. In a typical wireless network, if customer service performance measures are observed over a period of time to not be at the required level, then the transmitters must be repositioned, their signal strengths and frequencies recalibrated or the network capacity must be increased.

Capacity in these networks can be improved in the following ways. Firstly additional transmitters can be added with the fixed overlapping cells frequencies calculated so as to minimize interference. Alternatively power settings, and thus coverage areas, may be reduced so more transmitters can be placed in the given area. Usually it is impractical to frequently manipulate the transmitter power during a short period of time and so this option is not considered.

The decision as to which method to use to improve performance of these networks involves the consideration of many factors and is made over a long time frame. Significant discussion, planning and the use of “RF” specialists is often involved. In the Bluetooth network, the decision to involve more base stations in satisfying customer requirement, whilst maintaining a level of quality throughout the system must be made quickly. Also these decisions must be made frequently so as to adapt to the dynamically changing user requirements.

When a mobile unit (commonly referred to as Mobile Stations (MS)) is in communication with a Base Station, and the Mobile Station is actually moving, it may be necessary—because the Mobile Station moves away from the Base Station and the signal between the two becomes too weak to enable acceptable communication—to transfer the communication link from the Mobile Station to another Base Station with improved link quality. Transferring a Mobile Station from a serving Base Station to a new Base Station is called “Handoff”. At present, there is no existing technique for performing handoff over Bluetooth.

### DISCLOSURE OF THE INVENTION

According to the present invention, there is provided a method for minimising signal interference within a wireless network comprising a plurality of fixed terminals in wireless communication with one or more mobile terminals roaming within the network, communication links between the fixed and mobile terminals, the method including the steps of generating an integer linear programming problem of the form:

$$Min {\sum }_{j ∈ L}^{} ( M {p}_{j} - {\sum }_{i ∈ B}^{} {a}_{i}^{j} {x}_{i}^{j} ) \qquad ( 1 )$$

such that:

$$\begin{matrix}{\sum }_{i ∈ B}^{} {x}_{i}^{j} = 1 , j ∈ L & ( 2 ) \\ {\sum }_{j ∈ L}^{} {x}_{i}^{j} \leq {q}_{i} , i ∈ B & ( 3 ) \\ {x}_{i}^{j} \leq {z}_{i}^{j} & ( 4 ) \\ {\sum }_{i ∈ B}^{} {z}_{i}^{j} \leq {I}_{level} + {p}_{j} , j ∈ L & ( 5 ) \\ {p}_{j} \leq {I}_{threshold} , j ∈ L & ( 6 )\end{matrix}$$

where

$${z}_{i}^{j} = \{ \begin{matrix}1 , & if the signal of fixed terminal i is \\ & received by mobile j \\ 0 , & else\end{matrix} \\ {x}_{i}^{j} = \{ \begin{matrix}1 , & if fixed terminal i connects with mobile j \\ 0 , & else \end{matrix}$$

solving the above relaxed problem (1) to (3); determining if the solution satisfies constraints (4) to (6), and, if the solution does satisfy these constraints, using the solution to determine the communication links between the fixed and mobile terminals.

Solving this problem allows the communication links between fixed and mobile terminals that will minimize interference within the wireless network, while maximizing link quality, to be determined.

The relaxed problem can be solved by creating a first bipartite graph with the set of fixed and mobile terminals, applying weightings to the edges of the first bipartite graph to create a weighted bipartite graph, solving an optimal assignment problem for the weighted bipartite graph to derive a second graph having a second set of edges, to determine a new set of connections between mobile and fixed terminals.

The optimal assignment problem can be solved using a Kuhn-Munkres algorithm.

If constraints (4) to (6) are not satisfied, then the method may include the further step of applying an iterative heuristic.

The iterative heuristic may be a restricted tree search technique, such as a limited discrepancy search.

Alternatively, the iterative heuristic may include the step of firstly reducing signal coverage for a particular fixed terminal while maintaining communication links. The iterative heuristic may further include the step of considering whether any one mobile station should be in communication with another fixed terminal instead of the one with which it is presently in communication with.

According to another aspect of the present invention, there is provided a wireless network located within a network environment and comprising a plurality of fixed terminals in communication with one or more mobile terminals roaming within the network, the network including control means operable to solve an integer linear programming problem of the form:

$$Min {\sum }_{j ∈ L}^{} ( M {p}_{j} - {\sum }_{i ∈ B}^{} {a}_{i}^{j} {x}_{i}^{j} ) \qquad ( 1 )$$

such that:

$$\begin{matrix}{\sum }_{i ∈ B}^{} {x}_{i}^{j} = 1 , j ∈ L & ( 2 ) \\ {\sum }_{j ∈ L}^{} {x}_{i}^{j} \leq {q}_{i} , i ∈ B & ( 3 ) \\ {x}_{i}^{j} \leq {z}_{i}^{j} & ( 4 ) \\ {\sum }_{i ∈ B}^{} {z}_{i}^{j} \leq {I}_{level} + {p}_{j} , j ∈ L & ( 5 ) \\ {p}_{j} \leq {I}_{threshold} , j ∈ L & ( 6 )\end{matrix}$$

where

$${z}_{i}^{j} = \{ \begin{matrix}1 , & if the signal of fixed terminal i \\ & is received by mobile j \\ 0 , & else\end{matrix} \\ {x}_{i}^{j} = \{ \begin{matrix}1 , if fixed terminal i connects with mobile j \\ 0 , else\end{matrix}$$

by solving the above relaxed problem (1) to (3); and to determine if the solution satisfies constraints (4) to (6), and, if the solution does satisfy these constraints, using the solution to determine the communication links between the fixed and mobile terminals.

The control means may be operable to solve the relaxed problem by creating a first bipartite graph with the set of fixed and mobile terminals, by applying weightings to the edges of the first bipartite graph to create a weighted bipartite graph, and by solving an optimal assignment problem for the weighted bipartite graph to derive a second graph having a second set of edges, to determine a new set of connections between mobile and fixed terminals.

The optimal assignment problem can be solved using a Kuhn-Munkres algorithm.

If constraints (4) to (6) are not satisfied then the control means is further operable to apply a restricted tree search technique.

The restricted tree search technique may be a limited discrepancy search.

### BRIEF DESCRIPTION OF THE DRAWINGS

The invention will now be described, by way of example only, with reference to the accompanying drawings, of which:

FIG. 1 is a schematic illustration of a network comprising a plurality of wireless units in a small environment;

FIG. 2 is a schematic illustration of the components of a wireless network;

FIG. 3 is a schematic illustration of the components of a network controller for the network of FIG. 2;

FIG. 4 is a schematic illustration of the components of bluetooth base station units used in the present invention;

FIG. 5 is a schematic illustration of the handoff routine as performed in the embodiment described herein;

FIG. 6 is a schematic illustration of an office for housing the wireless network of FIG. 1, with grid lines superimposed thereon;

FIG. 7 Is a schematic illustration of the network environment showing the locations of Base Stations and Mobile Stations within the grid;

FIG. 8 is a diagram illustrating Step 3 in the method for determining the weighting function, as used in the handoff check;

FIG. 9 is a first weighted bipartite graph as used in the Limited Discrepancy Search (LDS) technique; and

FIG. 10 is a second weighted bipartite graph as used in the LDS technique.

### BEST MODE(S) FOR CARRYING OUT THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In the present specification the term “fixed” is used in relation to terminals. In the present specification, this term is used to define a terminal that is fixed, at any one time, in relation to the mobile terminals. It should be understood that these fixed terminals are not permanently fixed at any one location and can be moved—indeed may often be moved within a network environment. This term should therefore not be construed in a limiting form.

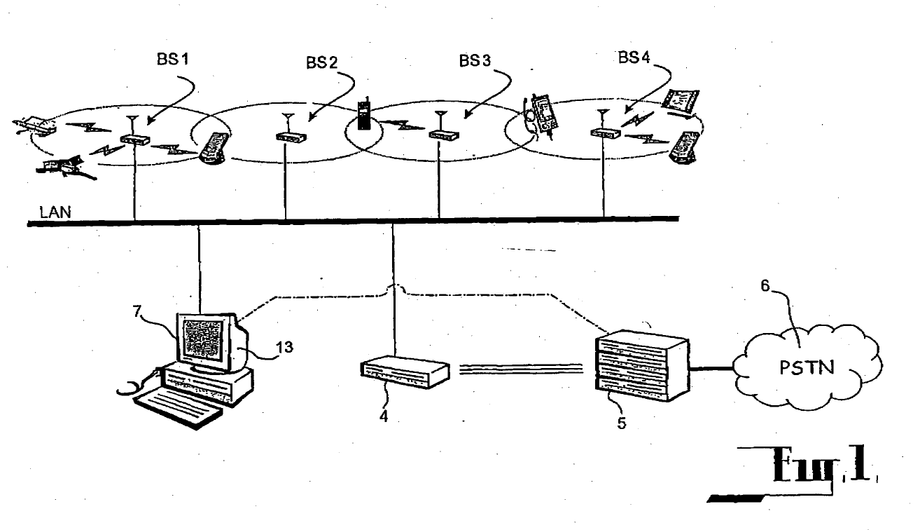

For the purposes of describing the present invention, consider network 100 with Bluetooth units in a normal office environment. This is illustrated in FIG. 1.

The network 100 includes a number—in this embodiment four—Bluetooth base stations, BS1, BS2, BS3, BS4, which are located throughout an office environment. Each base station can communicate with other Bluetooth units—including the other base stations—in a known manner. Other Bluetooth units may include, for example mobile phones, and PDA's. When in communication with each other, the units form a piconet as described in the description of the prior art.

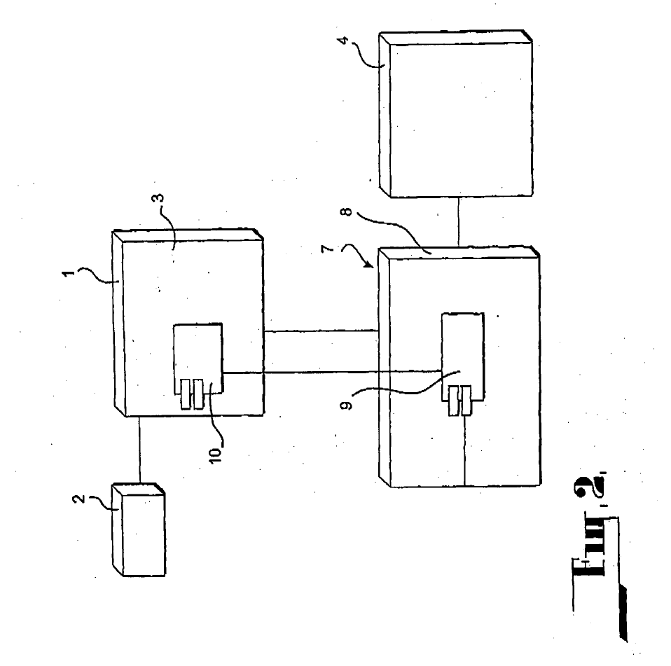

FIG. 2 illustrates schematically some of the components of the network as relevant to the present invention.

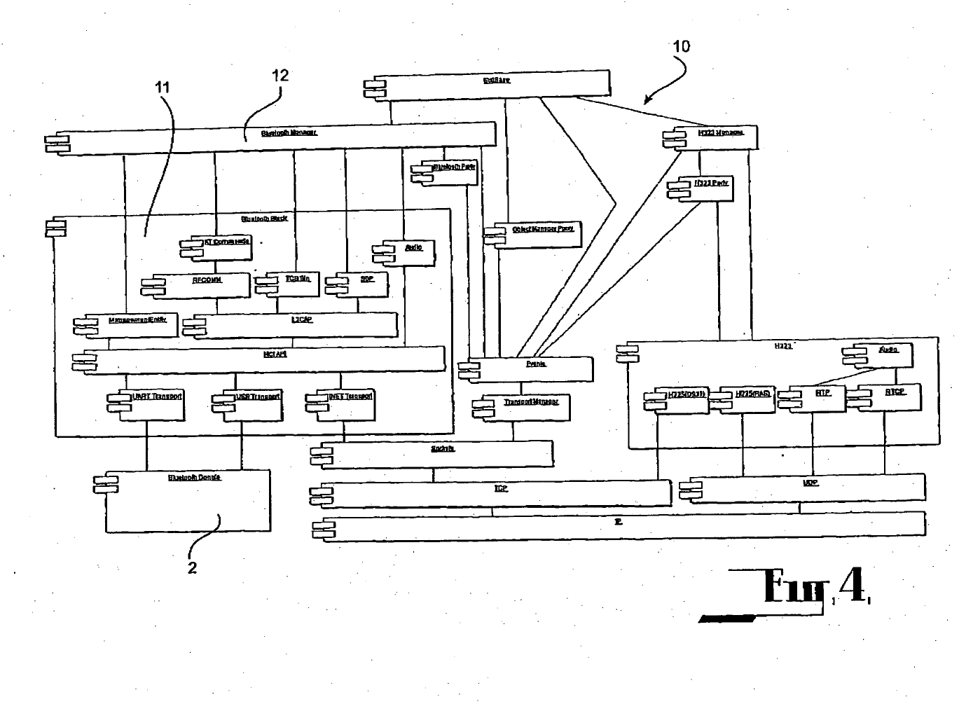

Each base station 1 comprises a so-called “dongle” 2 plugged into an interface of a conventional personal computer 3 and coupled to components necessary for operation of the base station. These components are commonly referred to as the “sofbase” 10, and are illustrated schematically in FIG. 4, which is a schematic stack of the components, with lines indicating appropriate communication between the relevant components. These components include the Bluetooth stack components 11, a manager 12, an H323 stack (whose function is equivalent to that discussed in relation to the service platform 9 below), an Object Manager proxy which manages system information communication with the service platform 9 (by means of its Object Manager), a Transport Manager manages all communication with the service platform 9 and other softbases.

Bluetooth devices, as well as other components that—in addition to the components mentioned above, in so far as they are not relevant to the present invention, need not be described in any further detail herein. Other Bluetooth devices, such as phones, and PDA's, include similar components, as, from the point of view of their operation as Bluetooth devices are concerned, their operation and components provided for their operation, are the same.

The base stations 1 are also coupled together to form a Local Area Network (LAN) along with a telephony gateway 4, which is coupled to a PABX system 5, and ultimately to a Public Switched Telephone Network (PSTN) 6. The use of LANs, telephony gateways, PABX's and PSTN's is well known to persons skilled in the art, and, insofar as it is not relevant to the present invention need not be described in any further detail herein. This network is illustrated schematically in FIG. 1.

Each base station 1 communicates with other mobile units/terminals within its range of operation. In this sense it is a cellular system with analogies to known cellular radio systems such as GSM and CDMA. In this network, the average cell size is 10 m in radius, and a maximum of 100 m

The network also includes a network controller 7.

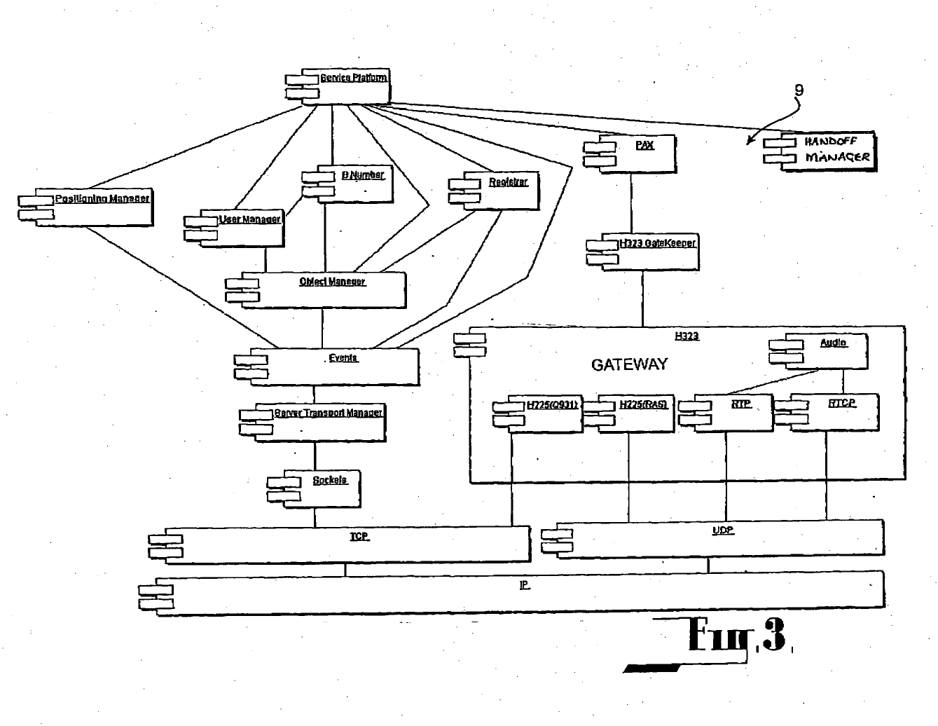

The network controller 7 comprises a number of components, which are illustrated schematically in FIG. 2. In particular, the controller includes a server 8 and a service platform 9. The components for the service platform 9 are illustrated schematically in FIG. 3, which is a protocol stack of the various components. The platform 9 includes an Object Manager, an H.323 Gateway, a positioning manager, a handoff manager, a user manager, a PAX, a Registrar, and a B-number, as well as other components.

The following components have the following functions:

Object Manager—manages all system information for base stations, mobile units, other terminals and users.

H.323 Gateway—manages call set up and routing, and allows voice data to be transmitted over the IP layer.

Positioning Manager—monitors base stations' positions, manages coverage and capacity, tracks mobile stations.

Handoff Manager—manages the handoff process.

User manager—manages user profiles.

PAX—manages call set-ups to/from the PBX/PSTN, and deals with the H.323 Gateway.

Registrar—deals with terminal registration and authentication, and keeps track of which base station is serving which mobile unit/terminal.

B-number—processes called numbers to check for validity and convert to routing numbers.

The means of communication between the various components is illustrated by the lines in FIG. 3. The Server Transport Manager manages communication with the softbase 10.

Unless otherwise discussed, the functions performed by the various components are known to persons skilled in the art, and insofar as they are not relevant to the present invention, need not be described in any further detail herein.

When Bluetooth devices are in communication with each other they have established a piconet. As mentioned above, up to eight Bluetooth devices can form a piconet, but, for clarity, the operation of only two devices is described, One Bluetooth device BS1 is a base unit (or base station), while the other is a Mobile Station MS1. The communication between the two has been established in the usual way in accordance with the Bluetooth protocols. The base station BS1 is the Master unit, and the mobile station MS1 is the slave unit.

In the network 100 it is important to ensure that the Base Stations are located to ensure that a mobile unit can communicate with it should it be necessary. Ideally base stations are located so that there is the required overlap between coverage areas, yet the expected interference from any two Base Stations transmitting at the same frequency is minimised.

The network is continuously monitored—using the network controller 7—to ensure that the Base Stations are located so as to achieve this objective. The usage of the Base Stations is also monitored. If any one Base Station is used too often in re-sequencing connections, then this can be identified as a “bottleneck”, and, for example, an extra Base Station can be placed nearby.

As Mobile Stations roam around the network 100 it may be necessary or advantageous for the Mobile Station to switch from being in communication with one Base Station to being in communication with another Base Station. This is known as handoff.

During the course of communication if the base station establishes that the quality of the communication links between the base station BS1 and the Mobile Station MS are below a predetermined level—for example by measuring Received Signal Strength (RSSI)—then it is necessary to transfer communication from the Base station BS1 to another Base Station BS2 which will provide better communication quality i.e. to perform a handoff.

It may be necessary to perform several Handoffs at any one time, in order to minimise the sum total interference within the network. It may also be necessary if a Mobile Station is specified as connecting to a Base Station that is already operating at full capacity.

Now consider the network that includes the four base stations BS1, BS2, BS3, and BS4 in an office environment. Within that network, there are also a number of mobile units or stations—in this embodiment four—MS1, MS2, MS3 and MS4.

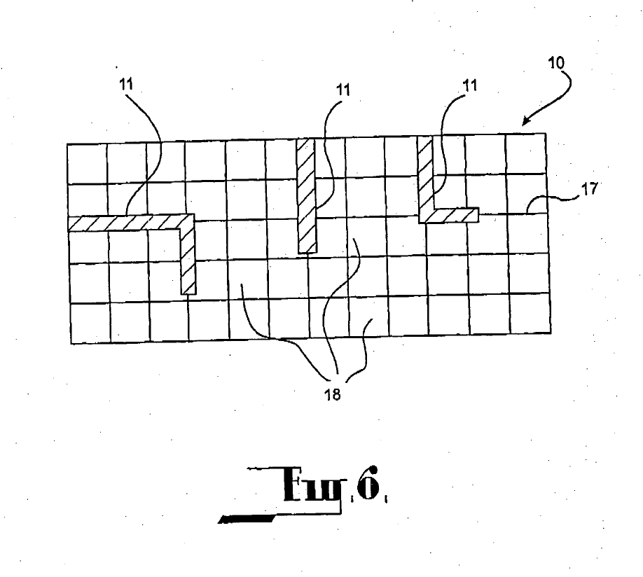

To model the environment e.g. office, the environment is divided into rectangular grid squares 18 using a grid system 17—illustrated in FIG. 6.

Details of the environment are provided to provide information on the size and shape of the area as well as information on any walls, or other obstacles that may provide attenuation for the radio signals to and from the base stations. This information can be supplied in any suitable form, but in the embodiment described herein, this may be in the form of a so-called CAD file, i.e. as produced in computer-aided design software packages. This has the advantage that such files may be readily available, as they may have already been drawn up when the environment was designed,

The office environment is then divided into the grid 17, including grid squares 18. Within this environment, there will be a subset of these grid squares 18 which may be used as base station locations. Usually, base stations have a substantially circular radiation or coverage pattern. However, significant obstacles e.g. office walls, can substantially attenuate the signal from the base station, and it is therefore possible, knowing the layout of the environment, to estimate areas of attenuation, and where the base station coverage is going to be less than “perfect”. It also possible to take account of the power of each base station, as the power of the base station will effect the range of coverage as well as any attenuation. Typically, the power levels can be discretised so that base stations are identified as having coverage with a radius of up to 5 m, up to 10 m and so on up to a value of 100 m.

For each grid square 18 (or set of grid squares 18) is data regarding potential connections each Mobile Station can make to Base Stations within its signal range. This data is initially predicted, then updated from historical observed behaviour. Also associated with each grid square 18 is a minimum number of Base Stations that must cover the location, so the expected number of calls to that location can be handled by the system. This can be deduced from historical behaviour and can be predicted using known communications traffic modelling techniques. The system is monitored to ensure these predictions are correct.

The centre of each grid square 18 becomes a possible location from which a Mobile Station may make a connection, with any inaccessible areas flagged out. In addition some grid squares 18 have Base Stations positioned at them. It is assumed that for each grid square 18 we can quickly determine the Base Stations that offer coverage to this location and each base station keeps a list of areas it covers. Also, the position of each Mobile Stations and Base Stations is known and the grid squares 18 they reside in can be quickly determined.

When the link quality between a Mobile Station and Base Station drops below a predetermined level e.g. the RSSI drops below a predetermined level, then the communication between the Mobile and Base Station needs to be transferred to another base station. Before initiating the handoff, the receiving Base Station needs to be identified.

The first step in determining which Base Station is to receive the handoff is to determine the velocity and direction of movement of the Mobile Station.

Briefly, a method for determining a Mobile Station's position comprises the following steps:

1. Obtaining regular RSSI measurements for every Mobile Station from as many Base Stations as possible. Include timing information so as to enable RSSI measurements from different sources to be related in time.

2. Calculating the Mobile Station's position using the RSSI measurements.

3. Estimating the Mobile Station's velocity (speed and direction) from previous position information.

This is explained in more detail below.

Consider a base station—BS1 in the embodiment described herein—in active communication with a mobile station MS1. It should be remembered that all Bluetooth units can operate as master and slave units—in this embodiment, the base station is the master unit, and the mobile station MS1 is the slave unit.

The base station BS1 measures RSSI information from MS1 (and any other Bluetooth units within it's range—in this embodiment MS1 and MS2). Similarly, all the other base stations BS2, BS3, B84 within the network are operable to carry out similar measurements for other Bluetooth units within its range. The base station BS1 is also operable to synchronise the clock information between the base station BS1 and the mobile station MS1, as is known, as RSSI measurements between the mobile station and each base station are not all done at the same time, it is necessary to incorporate time information for the interpolation. The RSSI measurements may be smoothed over time to minimise multi-path effects and temporary propagation path disturbances. This information is stored in a Measurement Database (not shown). The Measurement Database is provided in the positioning manager.

When a Mobile Station MS1 is engaged in an active connection with the Base Station BS1, then the measurements are reported when they change more than a configurable amount. If the RSSI falls below a configurable threshold, the handoff manager is informed and a handoff process is initiated. The request to perform a handoff is then sent from the network controller 7 to the Base Station that initiates the handoff. If the Mobile Station MS1 is idle, it is polled regularly and the measurements made. Each Base Station makes a request of each Mobile Station, for example, by making a brief ACL connection. The Mobile Station performs the request and sends the information back to the Base Station which then reports the measurements to the network controller 7, and waits for the next request from another Base Station, and so on. The polling periods are determined by the network controller 7 and passed to each Base Station, which then performs the requests to the Mobile Stations in turn. Synchronisation information from each Base Station is reported to the Measurement Database so that interpolation can be performed. The interpolation is discussed further below. The information reported allows measurements to be synchronised to within 100 ms.

This means the Measurement Database gets a regular stream of measurements for each Mobile Station from all Base Stations within range of the respective mobile station.

Similarly, the network controller 7 is operable to instruct the Base Stations to request the Mobile Stations within their reach to take measurements for the RSSI and time synchronisation information for all Base Stations in its range, and report, via the respective Base Station to the network controller 7. This information is also stored in the Measurement Database. The RSSI measurements are smoothed over time to minimise multi-path effects and temporary propagation path disturbances.

On the basis of the RSSI measurements taken by each Base Station, for each mobile Station within its reach, the system is able to determine the positions of the Mobile Stations within the network at any particular point in time. The position of the Mobile Stations are estimated by the process of the following;

1. Interpolating the readings from each base station so as to provide an estimated measure of the distance of each mobile station from each base station at a synchronised point in time

2. Applying the synchronised measurement data with base station position information to determine estimates of Mobile Station locations using a triangulation method. Three distance measurements from fixed position base stations are required to triangulate its position. Due to the fluctuations in RSSI readings, a greater number of readings (correlating to distance estimates) are used and a standard non-linear least squares fitting algorithm applied. The algorithm uses a sum of squares error function and finds the Mobile Station position that minimizes this function. The Base Station positions may be measured by hand, by GPS readings, or by any other suitable means.

3. Estimation of the velocity and direction of travel of each mobile station, by using the positions of the Mobile Station at different points in time and averaging them over a small time window.

4. Reporting of results to the Measurement Database.

By carrying out these measurements, it is possible to build up a “map” of how mobile stations roam around the environment. Within an office environment there are usually a number of major thoroughfares, a number of minor thoroughfares and multiple feeder pathways—for example, from an individual's desk to a main route through the office. The routes taken by Mobile Stations are recorded over time and a traffic density map is built up. This traffic density map is overlaid on the base station coverage and attenuation maps to build up path probability statistics, i.e. the system is able to determine the probable paths that a Mobile Station will take, If paths change due, for example, to a reorganisation of the office space, then the system will automatically adjust its information. While there will be a period of time when actual paths do not match predicted paths, this period can be fine-tuned by controlling sensitivity weightings that shape the delay between new and old data taking precedence.

Recording time information allows a further refinement to the path prediction algorithms. This supports time of day phenomena like coffee breaks, regular meetings and start/end times being identified and used to assist the accuracy of the path prediction. For example, at the end of the day, the chances are that most of the traffic will be from individual Mobile Stations moving towards the exit door of the office.

From this information, it is possible to identify path segments that Mobile Stations have a very high probability of following from start to finish. Thus any Mobile Station journey consists of a number of segments. A path segment is a path from one grid square to an adjacent grid square. At the junction of segments, the Mobile Station will follow one of several possible segments, and the system must then determine the probabilities of which of the segments the mobile Station is likely to follow. The probability that a Mobile Station will choose a specific segment is made up of two elements. The first element is the probability derived from the total Mobile Station population behaviour at that intersection. The second element is the probability derived from the behaviour of that specific Mobile Station at that intersection in the past. It is therefore necessary to derive information about an individual Mobile Station's probable behaviour, as well as for the whole population of Mobile Stations.

Just as the probability map for the whole Mobile Station population is built up, so is the probability map for each individual Mobile Station. The individual probability will usually have a higher weighting than the general one, thus supporting better prediction when a mobile station breaks away from the pack. The obvious example of this occurs when a Mobile Station consistently takes what is generally a low probability segment because that is, for example, the route to their desk. In this situation, the system should give the highest probability to the desk branch for this specific Mobile Station, but give the highest probability to the thoroughfare path for all other terminals.

Predicting the path of a mobile station involves combining the following elements.

The mobile station's current position and path segment;

Its velocity vector; and

For each potential path segment:

Individual Path Probability

Network Path Probability

Cell capacity probability

Time of day weighting

Handoff required weighting

Velocity vector weighting.

The time period between performing position estimates and path predictions is configurable but will normally be less than 1 second, Different configuration values may be used for terminals engaged in a call and for those that are idle.

Once a mobile station's probable path has been determined, then, from knowledge of the positions of the base stations, it is possible to determine those base stations, i.e. a set of base stations, to which the mobile station may connect.

In accordance with the present invention, an integer linear programming formulation is developed and analysed to produce an algorithm for keeping the signal interference below certain levels within the system. This is all carried out in the network controller 7. The secondary objective to maximize link quality is also incorporated into the formulation.

As discussed above, interference between neighbouring Base Stations may degrade signal quality. In the present invention, channel frequencies used by the Base Stations are assumed to follow a pseudo-random hopping sequence. By this we mean that at each instance and for each Base Station, a mathematical function simulating the properties of randomness is used to choose the frequency that each Base Station broadcasts on. This frequency is chosen from a limited number of possible channels. It is assumed the size of this set is sufficiently small so that above a certain threshold size, a number of base stations transmitting to the same user location will result in a significant degradation in quality.

Signal degradation is measured by the signal interference ratio (SIR) defined as the number of error free packets received divided by the total number of packets transmitted. Further, if a single Base Station transmits to two devices at a given location, then no interference occurs since the Base Station defines the hopping sequence. Lastly we assume the capacity of each Base Station is limited so that the chance of two or more Base Stations being required to satisfy a set of customers in the same vicinity is high.

In order to generate the integer linear programming problem, it is first necessary to define the following notation:

$${z}_{i}^{j} = \{ \begin{matrix}1 , & if the signal of softbase i is \\ & received by mobile j \\ 0 , & else\end{matrix} \\ {x}_{i}^{j} = \{ \begin{matrix}1 , if softbase i connects with mobile j \\ 0 , else\end{matrix}$$

From this, the problem to be solved to minimize interference while maximizing link quality is:

$$Min {\sum }_{j ∈ L}^{} ( M {p}_{j} - {\sum }_{i ∈ B}^{} {a}_{i}^{j} {x}_{i}^{j} ) \qquad ( 1 )$$

such that,

$$\begin{matrix}{\sum }_{i ∈ B}^{} {x}_{i}^{j} = 1 , j ∈ L & ( 2 ) \\ {\sum }_{j ∈ L}^{} {x}_{i}^{j} \leq {q}_{i} , i ∈ B & ( 3 ) \\ {x}_{i}^{j} \leq {z}_{i}^{j} & ( 4 ) \\ {\sum }_{i ∈ B}^{} {z}_{i}^{j} \leq {I}_{level} + {p}_{j} , j ∈ L & ( 5 ) \\ {p}_{j} \leq {I}_{threshold} , j ∈ L & ( 6 )\end{matrix}$$

In the above M is set to be a sufficiently large real number so that link quality will only be maximized providing it does not lead to an increase in interference. Thus (1) achieves our objective of minimizing interference as the primary objective and maximizing link quality as the second. Constraints (2) indicate that each mobile must be connected to one base station only. Constraints (3) say that each base station can make at most its maximum number of connections. Constraints (4) indicate that a mobile can only connect to a base station transmitting to its location. Constraints (5) says that the number of signals transmitting to a particular mobile location must be below a certain predefined limit but may increase at a penalty cost. (6) indicate how high above this predefined limit the number of base stations transmitting to a mobile location may be.

At regular time intervals, but particularly when a handoff is required, we look at solving the above problem to provide a set of connections between mobile stations and Base Stations that will minimize signal interference and, secondarily, maximize link quality. This problem is NP-Hard and, therefore, there is no guarantee that the optimal solution can always be found quickly. The solution is therefore to solve the relaxed problem (1)-(3), and, if this solution also satisfies (4) to (6), then this is a solution for (1) to (6). If however, the solution does not satisfy (4) to (6), then an iterative heuristic is applied. The iterative heuristic is outlined below.

To solve the relaxed problem, a bipartite graph is created to represent the current state of the system with the set of Base Stations forming vertices of one set of the graph and the set of Mobile Stations forming the other. An edge of the graph represents a connection from a Mobile Station to a Base Station.

Having created the bipartite graph, weights are applied to the edges. A technique for determining these weights is detailed below.

Having created the weighted bipartite graph, a maximum matching whose sum of edge weights is maximised is now determined. This is referred to in the art as an “Optimal Assignment Problem”. The use of bipartite graphs and ways to find a maximum (weighted) matching in bipartite graphs is well known, and is described in “Graph theory with Applications” by Bondy J. A., and Murty U. S. R; Elsevier, North Holland 1976. One way of finding maximum weighted matching is to use the known Kuhn-Munkres algorithm.

Maximizing the number of matchings using this scheme will yield a reallocation of base stations that are likely to follow the intended paths of the Mobile Stations in a high number of cases. Also the number of extra handoffs required to keep all Mobile Stations connected and having sufficient Link Quality will be kept to a minimum.

The output of the Optimal Assignment problem is a set of edges. The edges in the solution can be compared to the edges representing the connections between Mobile Stations and Base Stations. These edges represent SCO connections that could be made from the Mobile Station set to the Base Station set. These can either be determined either by a list, associated with the mobile's grid position, of base stations a mobile station could connect to, or by making short ACL pings from the Base Station to the Mobile Station to determine which Base Station can “see” the Mobile Station, and which cannot. Edges not in the original graph represent connections that should be made. Edges of the original graph not in the edge set represent connections that need to be broken. By looking at the edge connections to each Mobile Station, the handoffs and new connections that need to be performed can be determined. aᵢ^{j} is set sufficiently high for current connections. By doing this it is expected that a high number of current connections to remain in any solution to the above problem. Also, using this fact, an advanced solution to the relaxed problem is available (given by the current connections) and thus can be solved quickly.

Determination of the weighting function can use the following:

1. Significantly high weights are assigned to the current Mobile Station to Base Station active connections as the system will only want to handoff a Mobile Station to a new Base Station if it is necessary in order for all Mobile Stations to be connected. Similarly for a Mobile Station that is connected to a Base Station that requires handoff, a significantly low weight is assigned.

2. For other possible connections for each Mobile Station, the probable path the Mobile Station will take from the current location to a fixed distance is determined. The distance, eg. 20 meters, is made greater when the system isn't that busy and less when the system is busier. This is to restrict the calculations required. The path is made up of segments that represent travel from one grid square to another—as mentioned above.

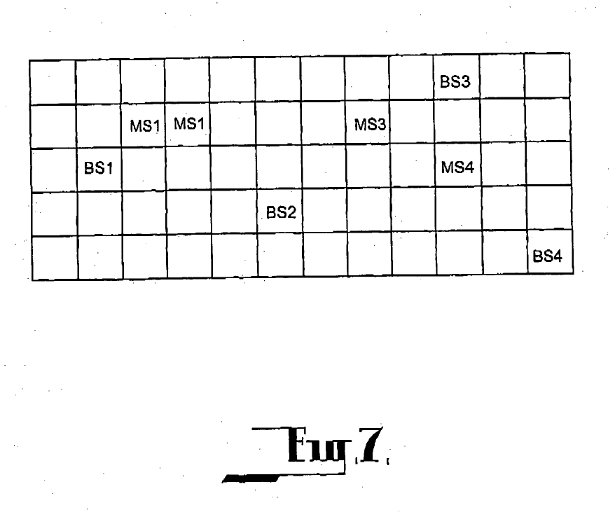

3. Weights, or rankings, are associated with each segment based upon the number of times the Mobile Station has travelled from the current grid square to another divided by the total number of times the Mobile Station has moved from the current grid square to another. Thus these weights are effectively probabilities that the segment will be used. One possible way to calculate the weights is to look at each of the segments in turn and calculate the probability the Mobile Station will arrive at each of its possible destinations. At each step probabilities are calculated for the most likely path, with probabilities associated with edges between the Mobile Station and Base Station on least likely paths not refined. An example is given in FIG. 7. These weights are then assigned to corresponding edges in the graph.

4. Finally the edge weights are adjusted by a given factor that represents some secondary objective depending on the application. For example if it is wished to use as few base stations as possible then a higher factor is associated with edges to base stations currently connected to a Mobile Station than edges associated with base stations which aren't currently utilized.

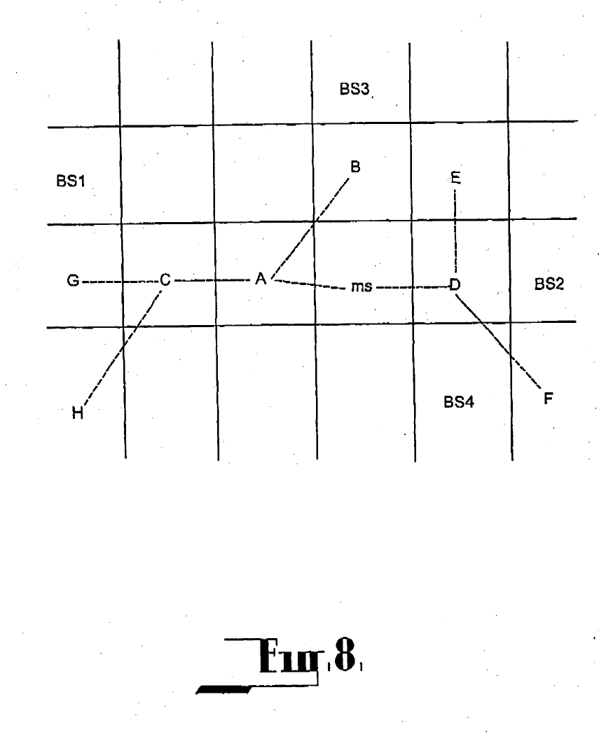

In FIGS. 8A, B, C, D, E, F, G and H represent grid squares in the grid system that a Mobile Station (MS) can move to. At A the Mobile Station can then move to grid squares B, C or back to its current position.

At D the Mobile Station can move to E, F or back to its current position. At C the Mobile Station travels to G or H or back to A. Say it is wished to predict the Mobile Station path up to 3 grid squares ahead.

All of the Base Stations in FIG. 8 cover the current Mobile Station (MS) position. BS2 and BS4 also cover positions D, E and F; BS1 also covers positions A, C, G and H; and BS3 also covers A and B. Say the Mobile Station (MS) has a 0.9 chance of travelling from its current position to A and a 0.1 chance of travelling to D. If arriving at A, the Mobile Station has a 0.6 chance of travelling to C, a 0.3 chance of travelling to B and a 0.1 chance of returning to its current position. Arriving at C the Mobile Station has a 0.7 chance of travelling to G, a 0.3 chance of travelling to H and a 0.0 chance of returning to A. Arriving at D the Mobile Station has a 0.8 chance of travelling to E, a 0.1 chance of travelling to F and a 0.1 chance of returning to its original position. The most probable path for the Mobile Station to follow Is to travel to A then C then G. Edge weights are calculated as follows,

Since the Mobile Station is unlikely to travel to D the weight 0.1 is assigned to the edge corresponding to the possible connection between Mobile Station and BS2 and the edge corresponding to the possible connection between Mobile Station and BS4. These weights are not refined since this path is unlikely to be used by the Mobile Station.

Considering the most likely segment, weight 0.315 (0.9*0.3+0.9*0.1/2.0) is assigned to the Mobile Station, BS3 possible connection and 0.045 (0.9*0.1/2.0) to the Mobile Station, BS1 connection. The next most likely route that involves the Mobile Station travels to G after arriving at C is looked at. 0.162 (0.9*0.6*0.3) is added for the C, H segment and 0.0 (0.9*0.6*0.0) for the C, A one. Since this is the limit at which it is wished to calculate the predictions, 0.378 (0.9*0.6*0.7) is added to the Mobile Station, BS1 connection for the C, G segment. Thus the total weight for the Mobile Station to BS1 connection is 0.585 (0.045+0.162+0.0+0.378).

As mentioned above, if a solution to the relaxed problem does not result in a solution that satisfies the other constraints then an iterative heuristic is used.

In a first embodiment of the invention, a local heuristic embedded in a restricted tree search technique is used to find a solution. This search technique is called limited discrepancy search (LDS).

Limited discrepancy search (LDS) is a tree search technique introduced in the paper by William D. Harvey and Matthew L. Ginsberg. Entitled “Limited discrepancy search” in Proceedings of the Fourteenth International Joint Conference on Artificial Intelligence, Montreal, Canada, August 1995. (http://citeseer.nj.nec.com/harvey95limited.html).

LDS consists of a number of iterations where at each iteration a partial solution is improved. These heuristics are often called local search techniques. At the termination of the heuristic, a feasible solution has either been constructed or the heuristic has failed. At each iteration, the feasible solution is constructed by making a decision as to how the solution may best be improved. If the heuristic falls then it may be argued that this is because at some iteration a “wrong decision” was made.

In the present invention, in order to find a solution, it is not practical to exhaustively search the entire solution space due to the large number of possibilities. However, by back tracking to a iteration in the heuristic where a “wrong decisions” was made, making a different decision and redoing the remaining iterations, it may be possible for a feasible solution to be constructed. The case where the best improvement to the partial solution is not used is referred to as a “discrepancy”. If the decisions as to which improvement should be used can be ranked then the best choice has 0 discrepancies, the next best choice has 1 discrepancy and so on.

LDS works by imbedding the heuristic in a tree search technique. As is known in the art, trees comprise a root, nodes and branches. At each node of the tree, the heuristic is called, the decisions as to how to improve the partial solution ranked, and child nodes created,—provided the sum total of discrepancies on the path from the child node to the root of the tree is not more than a predetermined maximum amount. Thus a small fraction of the entire solution space, which in some sense is likely to contain a solution, is being searched, Child nodes are searched in order, from the least to the most sum total number of discrepancies. When a child node is chosen to be explored we first check to see if it can immediately be fathomed using a look-ahead check. The full details of how LDS implemented follows.

Consider a Mobile Station (say MS1) involved in a communication session with a Base Station (say BS1) with adequate signal strength yet who's SIR is below a certain threshold. The low SIR ratio is caused by other base stations' signals being transmitted to the MS1 location causing interference. It is possible that the SIR for MS1 can be improved by handing off calls associated with those Base Stations transmitting to the MS1 location to other base stations, thus reducing the signal overlap. To do this we create a second graph from that created in the solution of the “Optimal Assignment Problem”, and referred to from hereon as the Original Graph. The steps are outlined below.

1. For each Mobile Station experiencing an unreasonable level of signal interference, duplicate the vertex and add it to the second graph. Call this set of vertices MS′.

2. Duplicate all Base Stations connected to vertices of MS′ in the original graph. Call these vertices BS′.

3. Edges connecting the members of the MS′ and BS′ in the original graph, and their weights, are also duplicated and added.

4. Add duplicates of any Mobile Station connected to member of BS′ in the original graph to MS′ and duplicate the associated edges and weights.

5. Add an infinite capacity vertex to the set BS′. Call this vertex O′. Then for each vertex associated with members of MS′ connected to base stations in the original graph besides those of BS′, add an edge between the vertex and O′. Determine the maximum weight between the vertex of MS in the original graph and base station vertices not duplicated in BS′. Assign this weight to the new edge.

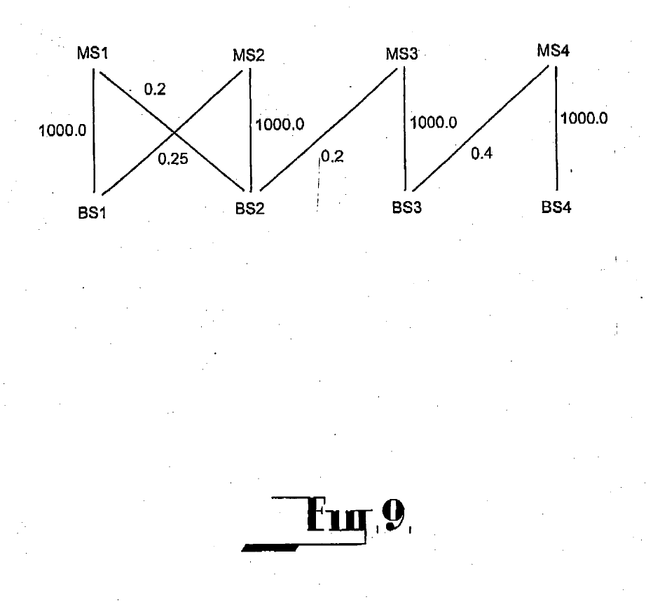

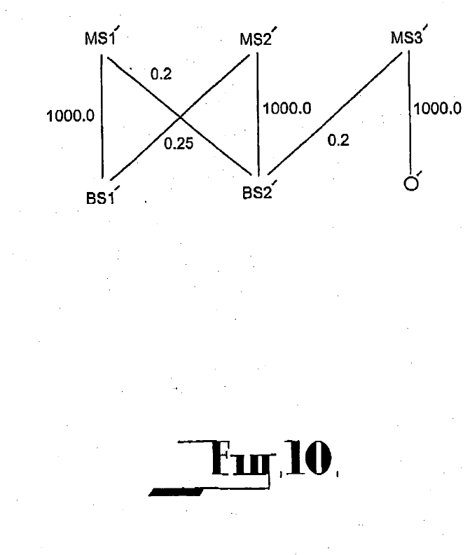

As an example refer to FIGS. 9 and 10. FIG. 9 illustrates an original graph, and FIG. 10 the second graph.

In FIG. 9, the 1000.0 weights denote current connections with lower weights denoting potential connections that can be made if a mobile is handed off. Assume these transmissions result in BS1, BS2 and BS3 all having signal overlap at the MS2 location, resulting in MS2 experiencing significant signal interference. If the second graph is constructed then it is given as illustrated in FIG. 10:

The following insertion heuristic in LDS is used. Initialise the set of connected terminals as empty. Then for each non-connected mobile determine the minimum change in the objective function (1) from connecting the mobile to one of the base stations in BS′ (i.e. changing the value of a xᵢ^{j} variable from 0 to 1), with a connection considered providing its inclusion in the solution results in constraints (2)-(6) remaining feasible. Choose the largest change of each of these minimum changes and set the corresponding xᵢ^{j} variable value to 1. Ties are broken randomly. Repeat until either all mobiles are connected, the current objective function value is at least the value of some other feasible solution or a mobile cannot be connected without losing the feasibility of (2)-(6).

When a child node is chosen to be explored then we know its best possible lower bound equals the current value minus the number of mobiles still to be connected multiplied by the maximum value of aᵢ^{j}. If this value is greater than or equal to the current best-known solution lower bound then this node is immediately fathomed.

Using the above example to illustrate the use of LDS, say M in problem (1) is set as 1000000.0, each base station has capacity 3 and it is required to keep the number of overlapping signals at each Mobile Station location to 2 or less, but may be increase to 3 at a penalty cost. Set the maximum number of discrepancies to 1, and an initial upper bound of infinity. The steps in the LDS heuristic are as follows.

At the root node of the search tree, the heuristic determines the minimum change in (1) for each unconnected mobile is −1000.0. Break the three way tie by choosing the MS1′-BS1′ connection. Create two child nodes corresponding to MS1′ connected to BS1′ (0-discrepancy) and MS1′ connected to BS2′ (1-discrepancy) the second best choice. Associate bounds of −1000.0 and −0.2 to each child node respectively.

Choosing the 0-discrepancy node, we find the minimum change in (1) for MS2′ and MS3′ is again −1000.0. That tie is then broken, and the MS2′-BS2′ connection is chosen. Create two child nodes corresponding to the MS2′ connected to BS2′ (0-discrepancy) and MS2′ connected to O′ (1-discrepancy—best choice used for MS1′ and second best used for MS2′). Bounds of −2000.0 and −1000.25 are associated to the two child nodes respectively.

Choosing the 0-discrepancy node, it is found that the minimum change in (1) for MS3′ is −0.2. This is because if the MS3′-BS3′ connection is used then significant interference is experienced at MS2 resulting in the objective function value increasing by M−1000.0=1,000,000−1000.0. By creating two child nodes it can be seen that the O-discrepancy case is a feasible solution of (1)-(6). It's solution is to connect MS1′ to BS1′, MS2′ to BS2′ and MS3′ to BS2′. The new bound coming from this solution is −2000.2. The second best choice is also a feasible solution of (1)-(6) but its objective function value is higher and thus the node is fathomed.

If the node with the minimum discrepancy count and lowest bound were to be chosen, this would be the node with bound −1000.25 and corresponds to MS1′ connected to BS1′ and MS2′ connected to BS1′. Applying the heuristic, results in a feasible solution of −2000.25, by connecting MS3′ to O′. Note the second best solution is not considered as creating the child node results in a discrepancy count of 2.

Choosing the last child node in the search tree gives the node corresponding to MS1′ connected to BS2′ with bound −0.2. For this case, since the maximum aᵢ^{j} is 1000.0 and we still need to connect two more terminals in MS′, the best potential bound that can come from this node is −2000.2. Since this value is greater than the best-known feasible solution value, the node can immediately be fathomed. This completes the LDS search routine.

Next the chosen connections from the second graph are mapped back to the original graph. In the above example MS3′ is connected to O′ with weight 1000.0. The corresponding edge chosen to build the second graph is selected in order to find the base station MS3 connects to. Finally the required handoffs are found by comparing the original graph and the solution, and implemented.

In a second embodiment of the invention, the iterative heuristic is based on the following:

Firstly, the system looks at mobiles that have a too high level of interference due to the use of these connections. Initially it tries to keep the current connections and reduce interference by reducing the signal strength for particular base stations. This is achieved by initially looking at reducing power output to reduce the interference. If a particular Mobile Station is 10 m from a Base Station and connected to it, and if the Base Station is transmitting at 100 m range then any other Mobile Station within the signal range will experience some interference. Using the RSSI/distance relationship the signal range is reduced for some Base Stations transmitting to the location of the Mobile Station experiencing significant interference. This is done provided reducing the power keeps all areas of the office covered by at least one base station so a new user can be detected if they decide to join the system. If this is not successful it is iteratively considered whether other Base Stations may be better suited to be in communication with the Mobile Station. The full details are provided below.

Consider a Mobile Station (e.g. MS1) involved in a communication session with a Base Station (e.g.BS1) with adequate signal strength yet who's SIR is below a certain threshold. The low SIR ratio is caused by signals from other Base Stations being transmitted to the MS1 location causing interference. The system tries to improve SIR at MS1 by checking for the following:

1. Firstly the power level of one or more of the Base Stations transmitting to the MS1 location is checked to see if it may be reduced without compromising signal quality to any other device. In addition all areas within the office environment must remain covered by at least one base station so that if a new user wishes to join the system then this is immediately detected.

2. Next the system considers the set of Base Stations transmitting to the Mobile Station location. This set is then placed in an ordered list according to the following criteria: Of two base Stations, BS1 and BS2, BS1 would appear above BS2 in the list if it satisfies one of the conditions set out below (presented in order of importance):

a) BS1 is involved in less communication sessions than BS2;

b) Of these communication sessions, BS1 has more Mobile Stations moving away from it (as determined by the received signal strength in a known manner) from it than BS2;

c) BS1 has less Mobile Stations moving towards it than BS2;

d) The maximum signal strength of all Mobile Stations connected to BS1 is less than the maximum signal strength of all Mobile Stations connected to BS2.

The rational for the above ordering is as follows. Handing off a mobile from one base station to another will most likely result in less handoffs needing to be performed throughout the rest of the network than if two or more MS have their connections reallocated. Next preference is given to handing off mobiles that are moving away from base stations they are connected to rather than ones that are moving towards. Finally the system looks to transfer mobiles that are further away from their connecting base stations than those that are near them, as its possible these may need to be handed off to another base station anyway in the near future.

Each Base Station is tested in turn to see if handing off one or more of the Mobile Stations involved in a communication session with it, and possibly decreasing the coverage radius as in the first check, results in a decrease in the interference experienced at the location of MS1. Details of the handoff check are given below. The set of Mobile Stations for each Base Station are checked in order of increasing signal strength—i.e. the first Mobile Station is tested to see if handing it off to another Base Station will result in a decrease in interference at the location of MS1, then the first and second Mobile Stations are tested together to see if handing them off to other Base Stations results in a decrease in interference at the location of MS1 and so on.

In order to check whether it is possible to reduce the power level of one or more of the Base Stations transmitting to the location of MS1 without compromising signal quality, or coverage, the network controller 7 uses the modelled office environment described above.

Obviously each Base Station must communicate with the furthest Mobile Station communicating with it and must allow sufficient time for a handoff to be performed if the Mobile Station moves away form the Base Station. We calculate the signal coverage radius necessary to achieve this using the relationship between signal strength and distance. If using this coverage radius will result in a drop in interference at the location of MS1 then we check to see if reducing the signal strength to this new level will still keeps all grid squares in the grid covered by at least one Base Station. If so the reduction is implemented. Base Stations transmitting to the location of MS1 are checked in random order and this procedure is halted once a suitable reduction is found.

The handoff check is performed using the weighted bipartite graph technique as described above.

In order to carry out the handoff checks, and having built the required bipartite graph as outlined above, the handoff tests are performed by setting one or more of the corresponding current communication session edges to a large negative value and using the Kuhn-Munkres algorithm to solve the “Optimal Assignment Problem”. Note that we make use of other current communication sessions to initialise the Kuhn-Munkres algorithm as these form an initial partial matching in our graph. If an improvement in the level of interference is found at the location of MS1 which results in an increase in the objective function value of (1) then we do not accept the solution. Otherwise the change in the state of the network is accepted and the tests applied to any other Mobile Stations experiencing excessive interference. If no further improvements can be found the handoffs to be performed are implemented.

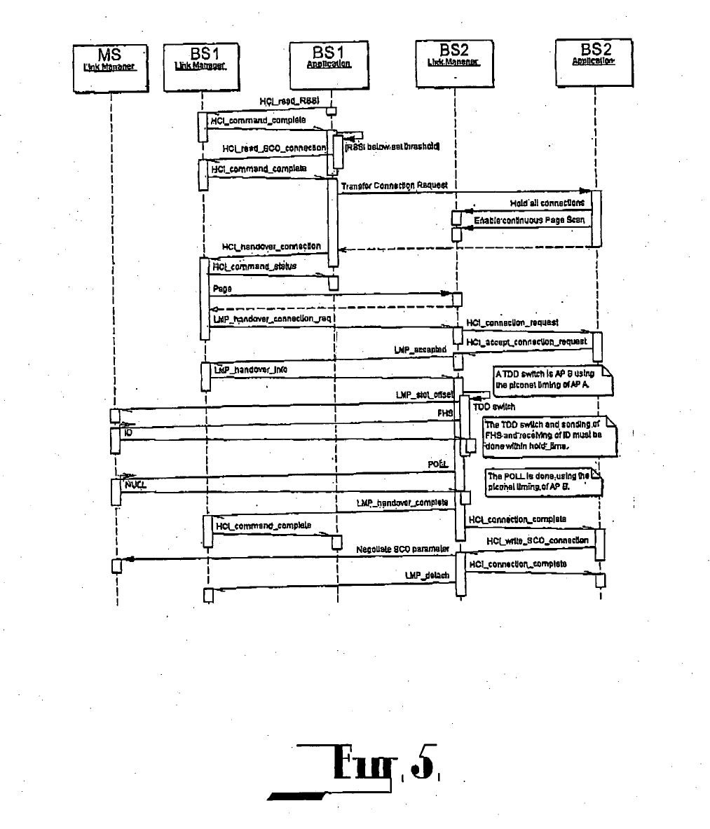

Once the required Handoffs have been determined then Handoff is performed. The handoff collaboration between two Base Stations BS1, BS2 and the mobile station MS is illustrated in FIG. 5, and is described below.

In order to perform handoff, new messages are needed, in addition to the standard, known messages detailed in the Bluetooth core specification, which, in so far as they are already known and are not relevant to the present invention need not be described in any further detail herein.

The new messages required, can be detailed as follows:

LMP_handover_connection_req

This message is similar to LMP_host_connection_req. It is sent from the first base station BS1 and is used to request the receiving base station BS2 to accept a handoff of the Mobile Station into its piconet. It contains the Bluetooth Address of the Mobile Station MS.

The receiving Base Station BS2 should respond with an LMP_accepted or LMP_not_accepted message.

LMP_handover_info

This message is used to inform the receiving Base Station B8S2 of the AM_ADDR for the Mobile Station MS and the amount of time, in slots, it has to handover the Mobile Station. It should also contain the supported features of the Mobile Station MS.

The hold_clk represents the value that the first Base Station BS1 clock will be when the receiving Base Station BS2 finishes the handoff process.

Note: Encryption must be disabled/turned off before the handover process is started.

LMP_handover_complete

This message is used to inform the first Base Station BS1 that the handoff of the Mobile Station has been successful or unsuccessful. If successful it is safe for the old Base Station BS1 to remove all information related to the Mobile Station MS. If unsuccessful the first Base Station BS1 can retry the process by sending the LMP_handover_connection_req again.

HCI_handover_connection

This HCI command is the start of the handoff procedure. It contains the connection_handle of the Mobile Station MS i.e the Slave device as well as the Bluetooth Address and Page information of the receiving Base Station BS2 ie. the new Master.

The following messages are known messages for communication between Bluetooth units and are used in the handoff process. However, they may have a new field/parameter added to them as set out below:

HCI_connection_request

This HCI event is sent when an LMP_handover_connection_req is received. It contains the Bluetooth Address of the Mobile Station MS with the Link_Type parameter—to set a new value for the handoff, when used as a parameter in the already existing HCI_connection_request message.

HCI_accept_connection_request

This HCI command is sent to accept the LMP_handover_connection_req. It contains the Bluetooth Address of the Mobile Station MS. The role is always 0×00 as the receiving Base Station BS1 will always be the Master of the new connection.

HCI_reject_connection_request

This HCI command is sent to reject the LMP_handover_connection_req. It contains the Bluetooth Address of the Mobile Station MS.

HCI_connection_complete

This HCI event is sent to indicate the completion of the handoff process. It contains the connection_handle for the Mobile Station MS on the new Base Station, the Link_Type parameter set to the new value for handoff and Encryption_Mode set to the encryption mode of the link before the handoff.

So that the Mobile Station is not aware of the transfer, Channel Identifiers (CID's) must be unique between all potential receiving Base Stations. This limits the number of simultaneous L2CAP connections to 65472 (16 bits of information with the values 0 to 63 reserved).

SCO handles are only used internally to the Link Manager. The SCO handles don't need to be unique if the Link Manager keeps track of the SCO handle value the Mobile Station has recorded as representing the SCO link between it and the Base Station. Internally the Base Station Link Manager's SCO handle just needs to be mapped to the connection_handle passed to the upper layers. The SCO handle, at the LMP level, is used as a common reference to the SGO link between two Bluetooth devices. The Link Manager only uses a SCO handle internally, any reference from upper layers to a SCO link is done via a connection_handle, which is supplied by the Link Manager to the Host Application. If the Link Manager maps a connection_handle to a Bluetooth device and its SCO handle, then the SCO handle value does not need to be unique. The Link Manager will only need unique SCO handles to a Bluetooth device with multiple SCO connections.

Before handoff can begin, the first base station BS1 must establish which other Bluetooth device can be used as the new base station BS2 i.e. which is to be the receiving Base Station. For example, the second Base Station could be a Base Station with a stronger signal strength located between the Mobile Station and the first Base Station. Once the first base station BS1 has determined the second base station BS2, then the first base station BS1 must transfer the communications link to mobile station MS to the second base station BS2. The handoff collaboration between the two Base stations BS1, BS2 and the mobile station MS is illustrated in FIG. 5.

As mentioned above, each Base Station is periodically measuring the RSSI between itself and any Mobile Station to which is in communication with. Other indicators of link quality can also be measured. When this value falls below a predetermined level then handoff is to be performed to the selected receiving Base Station BS2.

In preparation for the transfer, the timing information for the associated SCO channel reads a response to an HCI_read_SCO_connection message from the application of the first base station to the Link Manager of the first base station BS1. This information, along with information about the Mobile Station MS, is sent to the selected receiving Base Station BS2. An HCI_command_complete message it sent back to the Application, when this is done.

The first Base Station then requests a transfer to the receiving Base Station BS2. The connection between the first Base Station BS1 and the receiving Base Station is carried out in a known manner in accordance with the Bluetooth core specification. In this connection, the first Base Station BS1 operates as the master, while the receiving Base Station BS2 operates as the slave. In so far as this means of connection and communication is already known, it need not be described in any further detail herein. The actions that must be performed by the receiving Base Station BS2 in response to a transfer connection request are to hold all current connections, enter a continuos page scan mode, for a quick connection, and prepare to receive an HCI_connection_request from the first Base Station BS1 for the Mobile Station MS to be transferred. When these actions are done then the receiving Base Station BS2 should respond with a positive acknowledgment. If it cannot perform these actions a negative response is required.

On a positive response the Application of first Base Station BS1 sends HCI_handover_connection to start the handover process at the Link Manager level.

The first Base Station BS1 now connects, via a known Bluetooth Page process to the receiving Base Station BS2. This provides the piconet timing information for the first Base Station BS1 to the receiving Base Station BS2. This connection is used for all LMP messages between the two Base Stations BS1, BS2.

The first Base Station BS1 then sends an LMP_handover_connection_request to the receiving Base Station B32. This message causes the Link Manager of receiving Base Station BS2 to send an HCI_connection_request to its host Application. If the Host Application does not accept this request then it replies with an HCI_reject_connection_request. This will cause the Link Manager of the receiving Base Station BS1 to send LMP_not_accepted to the first Base Station BS1. The first Base Station BS1—in response to the LMP_not_accepted message—sends an HCI_connection_complete to its Host Application indicating the handoff has been rejected.

If the Application of receiving Base Station BS2 accepts the connection, then it responds with an HCI_accept_connection_request, and—in response to this—the Link Manager of the receiving Base Station BS2 sends an LMP_accept message to the Link Manager of First Base Station BS1.

When both the Base Stations BS1, BS2 have agreed to perform and support the handoff; the Link Manager of first Base Station BS1 suspends traffic to all slave devices, including the Mobile Station MS, and will suspend all slave connections, except that to the Mobile Station MS, for a period of time long enough to allow receiving Base Station BS2 to receive LMP_handover_info and perform the handoff of the Mobile Station MS. This suspension period is defined by a parameter/field hold_time in the LMP_handover_info message sent from the first Base Station BS1.

Once traffic is suspended, the first Base Station BS1's Link Manager sends LMP_handover_info to the receiving Base Station BS2. This message contains information about the Mobile Station, and how long the receiving Base Station BS2's Link Manager has to complete the handoff process. After this message has been sent, the first Base Station BS1 does not transmit to any slave, including the Mobile Station MS, until the suspend period has elapsed.

In response to receipt of the LMP_handover_info, the receiving Base Station BS2 schedules the handoff process of the Mobile Station MS as highest priority. If the handoff process is not complete before the suspension period i.e. hold_time, has expired then it shall be aborted immediately and an LMP_handover_complete message is sent to the first Base Station BS1 to indicate that the handoff has failed because hold_time had lapsed.

The handoff process consists of the same LMP messages as describe in the Bluetooth Core specification Part B section 10.9.3 “Master-Slave switch”—as described after the master and slave devices have switched and the new master transferring the old Master's Slaves into the new piconet. This is described with regard to the present invention below:

The receiving Base Station BS2 sends an LMP_slot_offset message to the Mobile Station MS. This message informs the Mobile Station MS of the difference in the slot boundaries between the first Base Station BS1's piconet and the receiving Base Station BS2's piconet.

The receiving Base Station BS2 uses the timing parameters from its connection to the first Base Station BS1, to temporarily assume the role of Master of the first Base Station's piconet and send a Frequency Hopping Scheme (FHS) packet to the Mobile Station MS. The FHS packet contains the information for the receiving Base Station BS2's piconet as described in the Bluetooth Core specification section Part B section 4.4.1.4.

The Mobile Station MS should respond to the FHS packet with an ID packet. The ID packet identifies the responding device—in this case, the Mobile Station MS. If not, then the FHS packet is sent repeatedly until the Mobile Station MS responds correctly or until the hold_time expires.

On receipt of the ID packet, the receiving. Base Station BS2 transmits a POLL packet using its own piconet timing parameters.

The Mobile Station MS should respond with a NULL packet confirming its switch to the new piconet parameters. If not, then the process loops back to the above process after the LMP_slot_offset was sent.

In this process the communication follows a Time Division Duplex (TDD) scheme where two communicating devices e.g. a master and a slave alternatively transmit. Normally, a master will transmit in an even slot and receive in an odd slot, and the slave vice versa. Because the receiving Base Station BS2 is also a slave of the first Base Station BS1 (which is also master of the Mobile Station MS), it needs to preform a TDD switch to be able to communicate with the Mobile Station MS when it is transferred into the receiving Base Station's piconet.

The reception of the NULL packet confirms that the Mobile Station has been transferred onto the receiving Base Station BS2's piconet. The receiving Base Station's Link Manager shall send LMP_handover_complete message to the first Base Station BS1 and an HCI_connection_complete message to the receiving Base Stations' Application indicating success.

When the first Base Station BS1 receives the LMP_handover_complete message indicating success, it responds by sending an HCI_command_complete message to its Application and cleans up any connection information related to the Mobile Station. This clean up process is carried out by the Application.

If an audio connection was transferred to the receiving Base Station BS2 as part of the handoff, then, when the HCI_connection_complete message is received by the Application of the receiving Base Station BS2, then, in response, it sends an HCI_write_SCO_connection message to inform its Link Manager of the SCO connection.

When HCI_write_SCO_connection is received the receiving Base Station's Link Manager shall renegotiate the SCO connection timing parameters to fit within the receiving Base Station BS2's piconet. When this negotiation is complete the Link Manager sends an HCI_connection_complete containing the connection information for the SCO connection to the Mobile Station MS. If the negotiation fails then the HCI_connection_complete indicates the reason for the failure and the Application for the receiving Base Station BS2 will either disconnect the Mobile Station MS or restart the handoff procedure.

An LMP_detach message should be sent to the first Base Station BS1 when the handoff has been successful or if the handoff attempt is aborted/failed. This severs the connection between the receiving Base Station BS2 and the Mobile Station.

Thus, Handoff is performed.

It will be understood that variations are possible within the scope of the present invention. For example, other path prediction methods could be used. Edge weights could be allocated on the basis of whether a mobile station moves towards or away from a base station. This can be determined from successive RSSI readings.

The claims defining the invention are as follows:

1. A method for minimising signal interference within a wireless network comprising a plurality of fixed terminals in wireless communication with one or more mobile terminals roaming within the network, communication links between the fixed and mobile terminals, the method including the steps of generating an integer linear programming problem of the form:
$$Min {\sum }_{j ∈ L}^{} ( M {p}_{j} - {\sum }_{i ∈ B}^{} {a}_{i}^{j} {x}_{i}^{j} ) \qquad ( 1 )$$
such that:
$$\begin{matrix}{\sum }_{i ∈ B} {x}_{i}^{j} = 1 , j ∈ L & ( 2 ) \\ {\sum }_{j ∈ L} {x}_{i}^{j} \leq {q}_{i} , i ∈ B & ( 3 ) \\ {x}_{i}^{j} \leq {z}_{i}^{j} & ( 4 ) \\ {\sum }_{i ∈ B} {z}_{i}^{j} \leq {I}_{level} + {p}_{j} , j ∈ L & ( 5 ) \\ {p}_{j} \leq {I}_{threshold} , j ∈ L & ( 6 )\end{matrix}$$
where
$$\begin{matrix}L = the set of mobile terminals \\ B = the set of fixed terminals \\ {z}_{i}^{j} = \{ \begin{matrix}1 , & if the signal of fixed terminal i is received by mobile j \\ 0 , & else\end{matrix} \\ {x}_{i}^{j} = \{ \begin{matrix}1 , & if fixed terminal i connects with mobile j \\ 0 , & else\end{matrix} \\ {q}_{i} = the capacity of fixed terminal i \\ {a}_{i}^{j} = expected signal quality if mobile terminal j connects with \\ fixed terminal i \\ {I}_{level} = preferred maximum number of signals from fixed terminals \\ overlapping any mobile terminal location \\ {I}_{threshold} = maximum extra number of extra fixed terminal signals \\ allowed above {I}_{level} , that can overlap a mobile terminal \\ location before service is inoperable \\ {p}_{j} = a non \text{-} negative penalty variable\end{matrix}$$
solving the above relaxed problem (1) to (3); determining if the solution satisfies constraints (4) to (6), and, if the solution does satisfy these constraints, using the solution to determine the communication links between the fixed and mobile terminals.

2. The method as claimed in claim 1, wherein the relaxed problem is solved by: creating a first bipartite graph with the set of fixed and mobile terminals;
applying weightings to the edges of the first bipartite graph to create a weighted bipartite graph;
solving an optimal assignment problem for the weighted bipartite graph to derive a second graph having a second set of edges to determine a new set of connections between mobile and fixed terminals.

3. A method as claimed in claim 2, wherein the optimal assignment problem can be solved using a Kuhn-Munkres algorithm.

4. A method as claimed in any of claims 1 to 3, wherein, if constraints (4) to (6) are not satisfied, then the method includes the further step of applying an iterative heuristic.

5. A method as claimed in claim 4, wherein the iterative heuristic is a restricted tree search technique is used.

6. A method as claimed in claim 5, wherein the restricted tree search technique may be a limited discrepancy search.

7. A method as claimed in claim 4, wherein the iterative heuristic includes firstly reducing signal coverage for a particular fixed terminal while maintaining communication links.

8. A method as claimed in claim 7, wherein the iterative heuristic may further include considering whether any one mobile station should be in communication with another fixed terminal instead of the one with which it is presently in communication with.

9. A wireless network located within a network environment and comprising a plurality of fixed terminals in communication with one or more mobile terminals roaming within the network, the network including control means operable to solve an integer linear programming problem of the form:
$$Min {\sum }_{j ∈ L} ( M {p}_{j} - {\sum }_{i ∈ B} {a}_{i}^{j} {x}_{i}^{j} ) \qquad ( 1 )$$
such that:
$$\begin{matrix}{\sum }_{i ∈ B} {x}_{i}^{j} = 1 , j ∈ L & ( 2 ) \\ {\sum }_{j ∈ L} {x}_{i}^{j} \leq {q}_{i} , i ∈ B & ( 3 ) \\ {x}_{i}^{j} \leq {z}_{i}^{j} & ( 4 ) \\ {\sum }_{i ∈ B} {z}_{i}^{j} \leq {I}_{level} + {p}_{j} , j ∈ L & ( 5 ) \\ {p}_{j} \leq {I}_{threshold} , j ∈ L & ( 6 )\end{matrix}$$
where
$$\begin{matrix}L = the set of mobile terminals \\ B = the set of fixed terminals \\ {z}_{i}^{j} = \{ \begin{matrix}1 , & if the signal of fixed terminal i is received by mobile j \\ 0 , & else\end{matrix} \\ {x}_{i}^{j} = \{ \begin{matrix}1 , & if fixed terminal i connects with mobile j \\ 0 , & else\end{matrix} \\ {q}_{i} = the capacity of fixed terminal i \\ {a}_{i}^{j} = expected signal quality if mobile terminal j connects with \\ fixed terminal i \\ {I}_{level} = preferred maximum number of signals from fixed terminals \\ overlapping any mobile terminal location \\ {I}_{threshold} = maximum extra number of extra fixed terminal signals \\ allowed above {I}_{level} , that can overlap a mobile terminal \\ location before service is inoperable \\ {p}_{j} = a non \text{-} negative penalty variable\end{matrix}$$
by solving the above relaxed problem (1) to (3); and to determine if the solution satisfies constraints (4) to (6), and, if the solution does satisfy these constraints, using the solution to determine the communication links between the fixed and mobile terminals.

10. A network as claimed in claim 10, wherein the control means is operable to solve the relaxed problem by:
creating a first bipartite graph with the set of fixed and mobile terminals;
applying weightings to the edges of the first bipartite graph to create a weighted bipartite graph; and
solving an optimal assignment problem for the weighted bipartite graph to derive a second graph having a second set of edges, to determine a new set of connections between mobile and fixed terminals.

11. A network as claimed in claim 10, wherein the optimal assignment problem is solved using a Kuhn-Munkres algorithm.

12. A network as claimed in any one of claims 9 to 11, wherein, if constraints (4) to (6) are not satisfied, then the control means is further operable to apply an iterative heuristic.

13. A network as claimed in claim 12, wherein the iterative heuristic is a restricted tree search technique.

14. A network as claimed in claim 13, wherein the restricted tree search technique is a limited discrepancy search.

15. A network as claimed in claim 12, wherein the iterative heuristic includes firstly reducing signal coverage for a particular fixed terminal while maintaining communication links.

16. A network as claimed in claim 15, wherein the iterative heuristic further includes the step of considering whether any one mobile station should be in communication with another fixed terminal instead of the one with which it is presently in communication with.
